(19) United States
(12) Patent Application Publication
(10) Pub. No.: US 2026/0281228 A1
(43) Pub. Date: Sep. 17, 2026

(54) Method for Automated Folder Creation and Categorization in Email Systems Based on Logical Rule Attribution

(71) Applicants: Ivan M Alexandrovich, Goodyear, AZ (US); Alexander M Alexandrovich, Goodyear, AZ (US)

(72) Inventors: Ivan M Alexandrovich, Goodyear, AZ (US); Alexander M Alexandrovich, Goodyear, AZ (US)

(21) Appl. No.: 19/235,192

(22) Filed: Jun. 11, 2025

(51) Int. Cl. H04M 1/72436; H04M 3/537; H04W 4/14

(52) U.S. Cl. CPC H04M 1/72436; H04M 3/537; H04W 4/14; H04M 2201/40; H04M 2201/42

(57) ABSTRACT

A method for organizing electronic communications within an email system based on user-defined rules. Each rule comprises one or more conditions involving predefined communication attributes and logical connectors. The system parses each rule into a logical expression and automatically creates a corresponding folder. Incoming communications are scanned for matching attributes, evaluated against the expression, and, if matching, automatically stored in the associated folder. The invention provides dynamic, rule-based organization of messages without requiring user intervention for sorting.

### BACKGROUND OF THE INVENTION

Conventional email platforms, such as Gmail, use labels and filters for basic message organization. As described in U.S. Pat. No. 7,814,155B2, labels function as visual tags applied to messages without affecting their storage location. Filters allow users to perform simple actions on messages based on predefined attributes but lack the capacity to dynamically route messages to rule-defined containers. These approaches are insufficient for users managing high communication volumes or requiring contextual, project-or client-specific organization.

The present invention overcomes these limitations by introducing manually created folders associated with logical rules. Each rule specifies conditions based on attributes such as email address, domain, phone number, keyword, or website, and is evaluated using logical operators. Incoming and historical communications are processed in real time, and those that satisfy the rule are stored in the corresponding folder. This system provides intelligent, scalable, and automated communication management not taught or suggested by the prior art.

### SUMMARY OF THE INVENTION

The invention provides a method for organizing electronic communications by associating user-defined folders with rule-based logical expressions. A user manually creates a folder and defines a rule composed of one or more conditions involving message attributes. Each incoming or historical message is scanned and evaluated against the logical expression associated with each folder. When a message satisfies the rule, it is automatically stored in the corresponding folder. The invention supports emails, SMS, and transcribed voice messages, offering cross-channel organization. This system improves efficiency, clarity, and context-aware storage for users across professional and academic domains.

### FIELD OF THE INVENTION

The present invention relates to the field of digital communication management. More specifically, it pertains to systems and methods for organizing electronic communications, such as emails and text messages, using user-defined rules associated with folders in an email system.

### DETAILED DESCRIPTION OF THE INVENTION

The present invention provides a method and system for organizing electronic communications within an email environment by enabling users to associate logical rules with user-created folders. These rules govern how communications—including emails, text messages, and phone call transcripts—are automatically evaluated and stored. This invention improves upon conventional email management tools by introducing active, rule-driven organization based on communication content, metadata, and sender-specific attributes.

Each folder within the system is created manually by the user through a graphical user interface (GUI). Once created, a rule is assigned to the folder. A rule is defined as a logical expression composed of one or more conditions. Each condition specifies a comparison against a specific communication attribute, such as an email address, a phone number, a domain name, a website reference, or a keyword. Conditions may be joined together using logical operators such as “AND” and “OR,” forming what is commonly referred to as Boolean logic. Boolean logic enables compound expressions that describe multi-faceted filtering criteria—for example, a folder could be configured to collect all communications from a particular domain and containing a specific keyword in the message body.

The system continuously scans a plurality of communications for attribute values. For email, metadata such as the sender's address, subject line, and body content are parsed. For SMS text messages, both the sender's phone number and message content are extracted. For voice calls, audio data is processed using speech-to-text transcription modules, and the resulting text is evaluated for keywords and phone numbers. Communications that satisfy the logical rule associated with any given folder are automatically routed and stored in that folder. The evaluation is performed in real time as communications are received, and may also be applied retroactively to historical messages within the user's account.

In one embodiment, the system is integrated with Twilio, a telecommunications platform-as-a-service (CPaaS) provider. This integration enables users to connect a Twilio-generated phone number to their Gmail account, such that all SMS messages and phone calls received through that number are logged and routed into Gmail via an associated API. The content of each message or call, once captured, is evaluated against the existing folder rules within the system. If a communication matches the rule associated with a folder—such as matching a sender's phone number or containing a pre-defined keyword—it is automatically stored in that folder. This allows users to organize not only their email communications but also SMS and voice interactions within a single, rule-based structure.

To extend the system's utility across platforms, a companion mobile application is available for both iOS and Android devices via the Apple App Store and Google Play Store, respectively. This application interfaces with the user's Gmail account and Twilio phone number, providing real-time access to the same folder structure and rule sets. Incoming phone calls and text messages sent to the Twilio number are processed through the app and logged in Gmail, with organizational logic identical to that used for emails. This architecture ensures that all communications—regardless of origin or format—are evaluated and stored in accordance with the same rules and user-defined logic.

The system is capable of associating a phone number with a folder by allowing the user to input the number directly as part of the rule definition. For instance, a user may create a folder labeled “Client A” and define its rule to capture any communication from the phone number +1 (310) 555-1234. All emails, SMS messages, and transcribed calls originating from this number are then automatically placed into that folder. The user may also include additional criteria in the rule, such as requiring that the message contain specific keywords like “contract” or “meeting.” This layered rule structure provides fine-grained control over communication sorting, making the system suitable for legal, business, academic, and personal use cases.

By associating folders with logical expressions and enabling cross-channel input processing, the invention transforms folders from static containers into intelligent, context-aware entities. Unlike traditional systems where filters and labels operate independently of storage logic, this invention consolidates tagging, evaluation, and storage into a single rule-driven process. Communications are not merely labeled or marked for attention; they are actively sorted into the appropriate containers at the time of receipt, eliminating the need for manual triage.

In summary, the system introduces a unified method for organizing all digital communications—emails, SMS messages, and phone calls—into user-defined folders governed by customizable logical expressions. Through integration with platforms like Twilio and synchronized access via a mobile application, the invention allows for intelligent, multi-channel communication management anchored directly within the user's Gmail account infrastructure.

1. A method for organizing electronic communications in an email system, the method comprising:
Receiving, via a user interface, a user-defined rule comprising at least one condition, wherein each condition specifies a comparison against an attribute selected from the group consisting of: an email address, a phone number, a domain, a website, and a keyword, and wherein the rule further comprises at least one logical operator selected from the group consisting of “AND” and “OR”;
parsing the user-defined rule to generate a logical expression that represents the condition or combination of conditions in a structured, machine-readable format;
creating a folder within the email system, the folder being associated with the logical expression;
scanning a plurality of incoming electronic communications for the presence of attribute values in metadata and message content;
evaluating each incoming electronic communication against the logical expression associated with the folder; and storing the electronic communication in the folder when the evaluation returns a true result.

2. The method of claim 1, wherein the user-defined rule comprises nested logical expressions using a combination of “AND” and “OR” operators to define complex evaluation logic.

3. The method of claim 1, wherein the attribute “keyword” is identified from natural language content in the subject line, body, or attachments of the electronic communication.

4. The method of claim 1, wherein the electronic communication comprises a text message (SMS), and the scanning step includes parsing the message body and associated metadata for attribute values.

5. The method of claim 1, wherein the electronic communication comprises a transcribed phone call, and the system includes a transcription module for converting audio input into searchable text.

6. The method of claim 1, wherein multiple folders may be associated with distinct logical expressions, and a single incoming communication may be stored in multiple folders when it satisfies more than one logical expression.

7. The method of claim 1, wherein the system generates a notification to the user when a folder is created or updated with a new communication.

8. The method of claim 1, wherein the logical expression is editable by the user after folder creation to update the associated rule without deleting the folder.

9. The method of claim 1, wherein the evaluation step is performed in real time as each communication is received by the email system.

10. The method of claim 1, wherein the electronic communication is received via an external telecommunication API, and the system associates the communication with a folder based on a rule that includes a matching phone number.

11. The method of claim 1, further comprising receiving an electronic communication through a third-party communication platform selected from the group including but not limited to: Twilio, Plivo, and Nexmo, wherein the communication is routed to the email system and evaluated against the logical expression associated with one or more folders.

12. The method of claim 1, further comprising interfacing with a mobile application configured to transmit received SMS messages or phone call metadata to the email system for evaluation and storage in accordance with the user-defined rule.
